(19) United States
(12) Patent Application Publication
(10) Pub. No.: US 2025/0259985 A1
(43) Pub. Date: Aug. 14, 2025

(54) BATTERY COMPONENT FABRICATION METHOD AND SYSTEM

(71) Applicant: Ford Global Technologies, LLC, Dearborn, MI (US)

(72) Inventors: DongHyun Lee, Northville, MI (US); Insik Jeon, Novi, MI (US); Gary Thomas Martini, Dexter, MI (US); Jonghwan Park, Ann Arbor, MI (US)

(21) Appl. No.: 18/436,172

(22) Filed: Feb. 8, 2024

(51) Int. Cl. H01M 4/04; H01M 10/0525

(52) U.S. Cl. CPC H01M 4/0435; H01M 4/0416; H01M 10/0525; H01M 2220/20

(57) ABSTRACT

A battery component fabrication method includes compressing a powder mixture to provide a composite film layer, surface treating the composite film layer, and compressing the composite film layer together with a foil layer to provide an electrode. The electrode provided by the method can be considered a dry electrode for a lithium-ion battery.

### TECHNICAL FIELD

This disclosure relates generally to fabricating battery components and, more particularly, to dry electrodes of lithium-ion batteries used in electrified vehicles.

### BACKGROUND

Electrified vehicles differ from conventional motor vehicles because electrified vehicles include a drivetrain having one or more electric machines. A battery pack can power the electric machines. The battery pack can include arrays of battery cells.

### SUMMARY

In some aspects, the techniques described herein relate to a battery component fabrication method, including: compressing a powder mixture to provide a composite film layer; surface treating the composite film layer; and compressing the composite film layer together with a foil layer to provide an electrode.

In some aspects, the techniques described herein relate to a battery component fabrication method, wherein the electrode is a lithium-ion battery electrode.

In some aspects, the techniques described herein relate to a battery component fabrication method, wherein the surface treating includes plasma surface modification.

In some aspects, the techniques described herein relate to a battery component fabrication method, wherein the surface treating includes corona treatment that uses a corona discharge plasma.

In some aspects, the techniques described herein relate to a battery component fabrication method, wherein the surface treating includes a laser treatment.

In some aspects, the techniques described herein relate to a battery component fabrication method, wherein the surface treating includes a light treatment.

In some aspects, the techniques described herein relate to a battery component fabrication method, wherein the composite film layer is a first composite film layer compressed against a first side of the foil layer and, further including compressing another powder mixture to provide a second composite film layer, surface treating the second composite film layer, and compressing the second composite film layer against an opposite second side of the foil layer.

In some aspects, the techniques described herein relate to a battery component fabrication method, wherein the powder mixture includes a binder material.

In some aspects, the techniques described herein relate to a battery component fabrication method, wherein the powder mixture is a dry powder mixture.

In some aspects, the techniques described herein relate to a battery component fabrication method, wherein the composite film layer is a dry electrode.

In some aspects, the techniques described herein relate to a battery component fabrication method, further including heating during the compressing.

In some aspects, the techniques described herein relate to a battery component fabrication method, further including compressing the powder mixture by calendering the powder mixture.

In some aspects, the techniques described herein relate to a battery component fabrication method, further including compressing the powder mixture using at least one roller of a calender.

In some aspects, the techniques described herein relate to a battery component fabrication method, wherein the at least one roller is a heated roller that heats powder mixture during the compressing.

In some aspects, the techniques described herein relate to a battery component fabrication method, further including heating the composite film layer and the foil layer when compressing the composite film layer together with the foil layer.

In some aspects, the techniques described herein relate to a battery component fabrication method, wherein further including winding the composite film layer and the foil layer after compressing the composite film layer together with the foil layer.

In some aspects, the techniques described herein relate to a battery component fabrication system, including: a powder compression station that compresses a dry power into a composite film layer; a surface treatment station that surface treats a side of the composite film layer; and an electrode compression station that compresses the side of the composite film layer against a foil layer to provide an electrode.

In some aspects, the techniques described herein relate to a battery component fabrication system, wherein the electrode is a lithium-ion battery electrode.

In some aspects, the techniques described herein relate to a battery component fabrication system, wherein the surface treatment station is a plasma surface modification.

In some aspects, the techniques described herein relate to a battery component fabrication system, wherein the side is a first side, and the surface additionally treats an opposite, second side of the composite film layer.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a traction battery pack.

FIG. 2 illustrates an expanded, perspective view of the traction battery pack from the electrified vehicle of FIG. 1.

FIG. 3 illustrates selected portions of a battery component fabrication system according to an exemplary aspect of the present disclosure.

FIG. 4 illustrates selected portions of a battery component fabrication system according to another exemplary aspect of the present disclosure.

FIG. 5 illustrates selected portions of a battery component fabrication system according to another exemplary aspect of the present disclosure.

### DETAILED DESCRIPTION

This disclosure details processes for fabricating battery components and, in particular, fabricating electrodes of batteries using a dry process. In the past, wet processes have been used to fabricate such electrodes. The dry process does not typically involve solvents and drying times commonly associated with wet processes.

With reference to FIG. 1, an electrified vehicle 10 includes a battery pack 14, an electric machine 18, and wheels 22. The battery pack 14 powers an electric machine 18, which can convert electrical power to mechanical power to drive the wheels 22. The battery pack 14 can be a relatively high-voltage battery.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

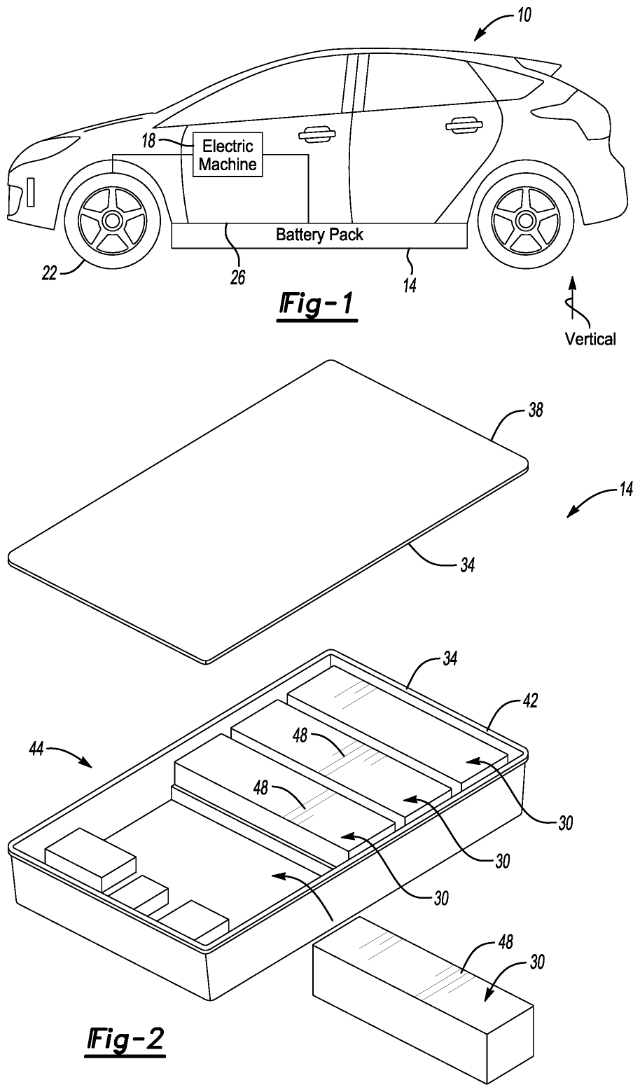

With reference now to FIG. 2, the battery pack 14 includes a plurality of battery arrays 30 held within an enclosure assembly 34. In the exemplary embodiment, the enclosure assembly 34 includes an enclosure cover 38 and an enclosure tray 42. The enclosure cover 38 is secured to the enclosure tray 42 to provide an interior area 44 that houses the plurality of battery arrays 30.

The battery arrays 30 each includes a plurality of battery cells 48 (or simply, “cells”) stacked side-by side relative to each other. Although a specific number of cells 48 and arrays 30 are illustrated in the various figures of this disclosure, the battery pack 14 could include any number of arrays 30 having any number of cells 48. In other words, this disclosure is not limited to the specific configuration of cells 48 and arrays 30 shown in FIG. 2.

The battery cells 48 supply electrical power to various components of the electrified vehicle 10. The battery cells 48 each include a respective electrode that is fabricated using a dry electrode fabricating process. Such electrodes can be provided by compressing a powder mixture into a film, which is then bonded to a foil without utilizing wet solvents or a wet slurry. The battery cells 48 are lithium-ion battery cells in this example. In other examples, the battery cells 48 can be solidum-ion, lithium-sulfur, or all solid electrolyte batteries with dry electrodes.

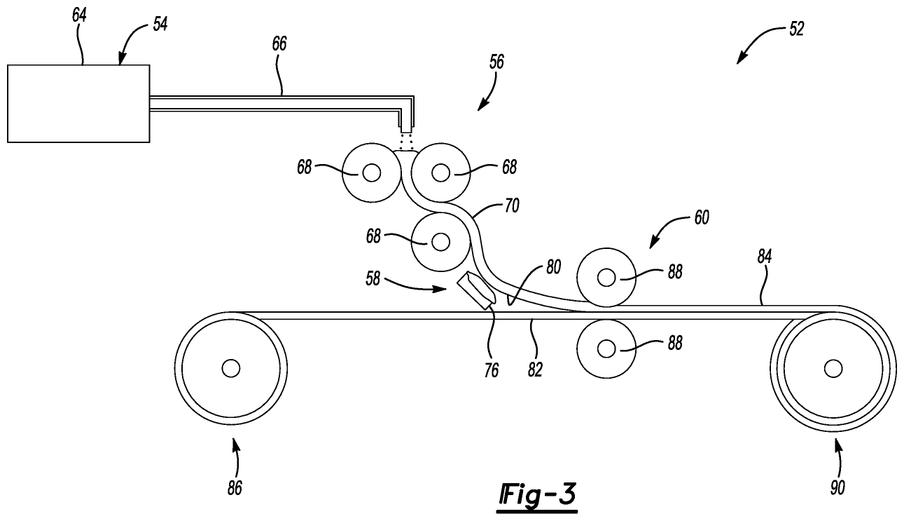

Referring to FIG. 3 with continuing reference to FIG. 2, an example battery component fabrication system 52 includes, among other things, a powder supply 54, a powder compression station 56, a surface treatment station 58, and an layer compression station 60. A method of fabricating electrodes for the battery cells 48 the battery pack 14 includes, generally, compressing powder from the powder supply 54 to provide a layer, surface treating that layer, and then joining that layer to a foil.

In this example, the powder supply 54 contains a dry powder mixture 64 including, among other things, active materials, binders, and conductive agents. The binders can be fluoropolymers, such as polytetrafluoroethylene and polyvinylidene fluoride, polyolefins, polyurethane, acrylics, sericin, protein-based, etc. The binders can be of a single use or a mixture with two or more polymers. Additives that include a limited amount of solvent can be added to facilitate processing or electrode performance.

The system 52 include a conduit 66 that conveys the dry powder mixture 64 from the powder supply 54 to the powder compression station 56.

The example powder compression station 56 is a multi-roll calender system. At the powder compression station 56, the dry powder mixture 64 is compressed—here by three calender rollers 68—into a composite film layer 70. In other examples more than three calender rollers 68 can be used. The rollers 68 can be heated to heat the dry powder mixture 64 as the dry powder mixture 64 is compressed.

From the powder compression station 56, the composite film layer 70 passes through the surface treatment station 72, which uses at least one surface treatment device 76 to treat a surface 80 of the composite film layer 70. The surface treating can be, for example, a plasma surface modification, a corona treatment that uses a corona discharge plasma, a laser treatment, a light treatment or some combination of these. A distance between the surface 80 of the composite film layer 70 and the surface treatment device 76 can be from 0 to 1.25 meters.

From the surface treatment station 58, the composite film layer 70 passes to the layer compression station 60, which compresses the composite film layer 70 together with a foil layer 82 to provide an electrode sheet 84. The foil layer 82 is unrolled from a foil roll 86 and routed to the layer compression station 60. The foil layer 82 can be aluminum, copper, or some other material. The selection of the material for the foil layer 82 can depend on whether an anode electrode sheet or cathode electrode is desired.

In this example, the layer compression station 60 is a calender system that compresses the composite film layer 70 together with the foil layer 82 using at least one calender roller 88, which can be a heated roller.

The electrode sheet 84 from the layer compression station 60 can be wound into an electrode roll 90. When assembling the battery cells 48, the electrode sheet 84 can be unwound from the electrode roll 90 and cut to a desired size for use as an electrode in one of the battery cells 48. Again, in this example the electrode is an electrode for a lithium-ion batteries, and the electrode is a dry electrode.

The surface treatment of the surface 80 of composite film layer 70 prior to compressing the composite film layer 70 against the foil layer 82 can, among other things, help to activate binders within composite film layer 70. Activating the binders helps to bond the composite film layer 70 to the foil layer 82 at the layer compression station 60.

The embodiment of FIG. 3 can be considered a fabrication system that has a single side foil coating and a single side treatment. That is, the layer compression station 60 is used to compress a single foil layer together with a single composite film layer, and the single composite film layer is treated on only the surface 80 prior to being compressed together with the composite film layer.

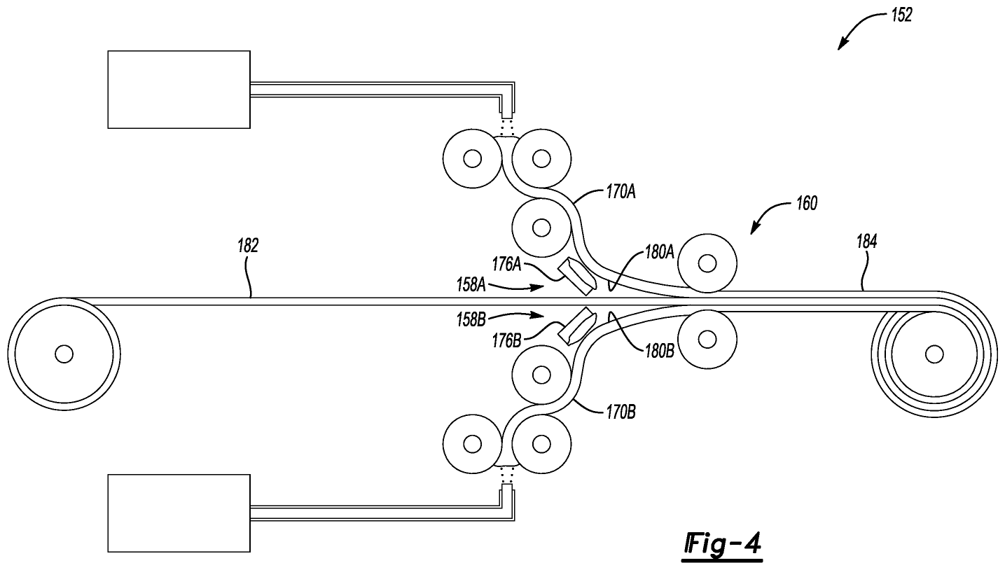

With reference to FIG. 4, a battery component fabrication system 152 can apply a first composite film layer 170A to a first side of a foil layer 182, and an second composite film layer 170B to an opposite second side of the foil layer 182. The electrode sheet 184 provided by the battery component fabrication system 152 thus includes a foil layer 182 sandwiched between the first composite film layer 170A and the second composite film layer 170B.

The system 152 includes a first surface treatment station 158A having at least one surface treatment device 176A that treats a surface 180A of the first composite film layer 170A prior to compressing the first composite film layer 170A together with the foil layer 182 at a layer compression station 160. The surface 180A interfaces directly with the foil layer 182 in the electrode sheet 184

The system 152 includes a second surface treatment station 158B having at least one surface treatment device 176B that treats a surface 180B of the second composite film layer 170B prior to compressing the second composite film layer 170B together with the foil layer 182 at a layer compression station 160.

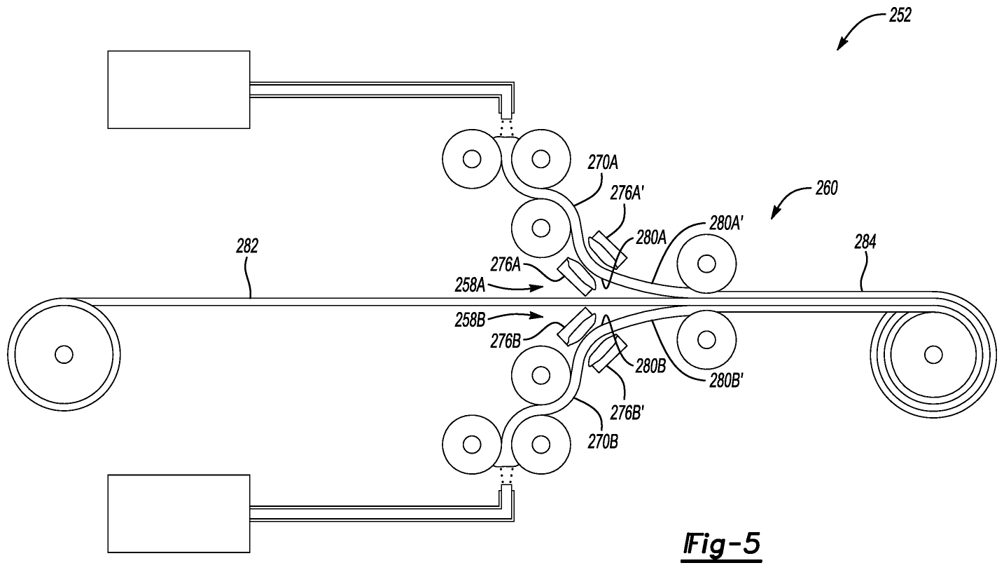

With reference to FIG. 5, a battery component fabrication system 252 can apply a first composite film layer 270A to a first side of a foil layer 282, and an second composite film layer 270B to an opposite second side of the foil layer 282. The electrode sheet 284 provided by the battery component fabrication system 252 thus includes a foil layer 282 sandwiched between the first composite film layer 270A and the second composite film layer 270B.

The system 252 includes a first surface treatment station 258A having at least one surface treatment device 276A that treats a surface 280A of the first composite film layer 270A prior to compressing the first composite film layer 270A together with the foil layer 282 at a layer compression station 260. The surface 280A interfaces directly with the foil layer 282 in the electrode sheet 284. The first surface treatment station 258A further includes a second surface treatment device 276A′ that treats a surface 280A′ of the first composite film layer 270A that is opposite the surface 280A.

The system 252 includes a second surface treatment station 258B having at least one surface treatment device 276B that treats a surface 280B of the second composite film layer 270B prior to compressing the second composite film layer 270B together with the foil layer 182 at a layer compression station 260. The surface 280B interfaces directly with the foil layer 282 in the electrode sheet 284. The second surface treatment station 258B further includes a second surface treatment device 276B′ that treats a surface 280B′ of the second composite film layer 270B that is opposite the surface 280B.

Treating the surfaces 280A′ and the surfaces 280B′ may be desired to inhibit the surfaces 280A′ and the surfaces 280B′ from adhering to the rollers at the layer compression station 260.

Features of some of the disclosed examples include facilitating adhesion between layers of a dry electrode by surface treating a composite file coating layer. This can help to reduce delamination. The surface treatment can be an in-line continuous process.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery component fabrication method, comprising:
compressing a powder mixture to provide a composite film layer;
surface treating the composite film layer; and
compressing the composite film layer together with a foil layer to provide an electrode.

2. The battery component fabrication method of claim 1, wherein the electrode is a lithium-ion battery electrode.

3. The battery component fabrication method of claim 1, wherein the surface treating comprises plasma surface modification.

4. The battery component fabrication method of claim 1, wherein the surface treating comprises corona treatment that uses a corona discharge plasma.

5. The battery component fabrication method of claim 1, wherein the surface treating comprises a laser treatment.

6. The battery component fabrication method of claim 1, wherein the surface treating comprises a light treatment.

7. The battery component fabrication method of claim 1, wherein the composite film layer is a first composite film layer compressed against a first side of the foil layer and, further comprising compressing another powder mixture to provide a second composite film layer, surface treating the second composite film layer, and compressing the second composite film layer against an opposite second side of the foil layer.

8. The battery component fabrication method of claim 1, wherein the powder mixture includes a binder material.

9. The battery component fabrication method of claim 1, wherein the powder mixture is a dry powder mixture.

10. The battery component fabrication method of claim 1, wherein the composite film layer is a dry electrode.

11. The battery component fabrication method of claim 1, further comprising heating during the compressing.

12. The battery component fabrication method of claim 1, further comprising compressing the powder mixture by calendering the powder mixture.

13. The battery component fabrication method of claim 1, further comprising compressing the powder mixture using at least one roller of a calender.

14. The battery component fabrication method of claim 13, wherein the at least one roller is a heated roller that heats powder mixture during the compressing.

15. The battery component fabrication method of claim 1, further comprising heating the composite film layer and the foil layer when compressing the composite film layer together with the foil layer.

16. The battery component fabrication method of claim 1, wherein further comprising winding the composite film layer and the foil layer after compressing the composite film layer together with the foil layer.

17. A battery component fabrication system, comprising:
a powder compression station that compresses a dry power into a composite film layer;
a surface treatment station that surface treats a side of the composite film layer; and
an electrode compression station that compresses the side of the composite film layer against a foil layer to provide an electrode.

18. The battery component fabrication system of claim 17, wherein the electrode is a lithium-ion battery electrode.

19. The battery component fabrication system of claim 17, wherein the surface treatment station is a plasma surface modification.

20. The battery component fabrication system of claim 17, wherein the side is a first side, and the surface additionally treats an opposite, second side of the composite film layer.
